(19) United States
(12) Patent Application Publication
(10) Pub. No.: US 2003/0177412 A1
(43) Pub. Date: Sep. 18, 2003

(54) Methods, apparatus and computer programs for monitoring and management of integrated data processing systems

(75) Inventor: Stephen J. Todd, Winchester (GB)

Correspondence Address: IBM Corp, IP Law, 11400 Burnett Road, Zip 4054, Austin, TX, 78758, US

(73) Assignee: International Business Machines Corporation, Armonk, NY

(21) Appl. No.: 10/195,152

(22) Filed: Jul. 11, 2002

(30) Foreign Application Priority Data
Mar. 14, 2002 (GB) 0205951.7

(51) Int. Cl. H04L 1/22

(52) U.S. Cl. 714/25

(57) ABSTRACT

Provided are rule-based methods, apparatus and computer programs for configuration checking and management in integrated data processing systems. A plurality of components of a system output configuration information (for example to one or more repositories), and a control tool accesses the output configuration information and applies configuration rules including consistency rules to check for consistency between the configuration information for the plurality of components. The results of the consistency check are then displayed on a display screen. The components can be a plurality of heterogeneous, federated components which are configured to interoperate within a data processing system or network. The configuration information of one component can include binding references to resources of other federated components. The ability to compare and check consistency between configuration information for multiple programs and different types of program is a significant improvement over current solutions which cannot identify inconsistent configurations until they fail at run-time. The consistency checking rules are preferably performed by a configuration checking tool located at a single point of control for the federated system, which processes suitably formatted facts about the system components.

### FIELD OF INVENTION

The present invention relates to data processing systems and methods and, in particular, to the monitoring and management of integrated systems.

### BACKGROUND

There have been great increases in recent years in the need for, and the achievement of, integration between different data processing systems. For example, most large enterprises make use of a variety of different computers and software and to manage their businesses successfully they need these computers and the software which runs on them to be able to exchange data effectively.

Some of the advances in systems integration have resulted from the increasing success of the Java programming language. Application programs written in Java run within a Java Runtime Environment (JRE) on any system having a JRE implementation. Other advances have been achieved by increased use of message oriented middleware programs such as IBM Corporation's MQSeries and WebSphere MQ family of products, and other business and systems integration software. (IBM, MQSeries and WebSphere are trademarks of International Business Machines Corporation. Java is a trademark of Sun Microsystems Inc.)

However, there remains a lack of fully integrated tooling and hence an inability to effectively manage these increasingly integrated systems. Currently, when the separate components of a complex data processing system are configured, the only configuration checking which is carried out is that which is provided by the configuration validity checking code integrated within individual component programs. Indeed, the conventional approach of computer program development is to make each separate component program autonomous, so it is no surprise that they each perform their configuration consistency checks independently of each other. While this is effective at checking validity internally for each component, it cannot avoid inconsistencies between components within the overall system configuration. For example, if a message queuing system is configured to send messages to a specified queue which is managed by a specified queue manager, validity checking code of the sender system will be unable to check at configuration time whether the target queue and queue manager exist. The result is that deployment of integrated data processing systems is often delayed by the need to resolve inconsistencies which are only identified when the new integrated system fails at run-time. The embedding of validity checking code within the main program code of each component makes it very difficult to get an overview of the entire system, and makes it impossible to perform consistency checks between the configuration requirements of different systems and programs.

U.S. Pat. No. 4,858,152 disclosed a solution which allows scanning of operating parameter values for multiple host systems and display of results on a single PC console. A program running at a single point of control is used to set thresholds for operating parameter values and to generate alarms when thresholds are exceeded, and the user is able to log on to host programs for diagnosis of alarm conditions.

Similarly, IBM's MQSeries Explorer management console component (for use with IBM's MQSeries message communication management software in a Windows NT environment) collects information from different MQSeries queue managers and displays on a single screen the definitions set on each of the systems. The MQSeries Explorer component prevents queue definitions being specified with an invalid queue name, but it does not make any comparison between definitions on different systems and so it exemplifies the current lack of provision of mechanisms for avoiding inconsistent configuration settings between systems. (Windows NT is a trademark of Microsoft Corporation)

Advances are being made in this area, such as by the Eclipse development tooling and support platform from the eclipse.org Consortium (IBM Corporation, Borland, Merant, RedHat and others). This capitalises on the success of the Java programming language for tool creation and supports the construction of a variety of software tools and their integration within and across different content types. Using the Eclipse platform, it is known for data from programs of different types to be displayed in separate windows of a display screen to enable management of the overall integrated system. While this, and other recent solutions, provide a number of significant steps beyond monitoring which is limited to only homogeneous peer systems—such as in U.S. Pat. No. 4,858,152—there is still inadequate provision for configuration checking and management of integrated heterogeneous systems.

### SUMMARY OF INVENTION

In a first aspect, the present invention provides a method for checking configuration of a plurality of components of a data processing system. The method comprises the steps, subsequent to the components outputting configuration information (for example to one or more repositories), of: accessing the output configuration information and applying configuration consistency rules to check for consistency between the configuration information for the plurality of components; and outputting the results of the consistency check.

The components preferably include a plurality of heterogeneous, federated components—preferably including one or more computer programs. In the context of the present application, ‘federated’ components are components which are configured to interoperate within a data processing system or network. The configuration information for federated components includes references to resources of other federated components to enable this interoperation—such as to enable run-time binding. ‘Heterogeneous’ components in this context are components providing different functions and performing different functional roles within the overall system or network.

The ability to compare and check consistency between configuration information for multiple programs and different types of program is a significant improvement over current solutions which cannot identify inconsistent configurations until they fail at run-time. The rules defining consistency requirements between different types of program will be referred to hereafter as federation rules. When a first component of a federated system includes configuration settings which reference resources of a second component, federation rules according to the present invention enable those configuration settings to be checked against the requirements of the second component. Prior art solutions do not allow this cross-checking.

The consistency checking rules are preferably performed by a configuration checking tool located at a single point of control for the federated system, which processes suitably formatted facts about the system components. The components' facts may be represented, for example, as Prolog facts for processing by Prolog-based rules. The output results are preferably displayed on a single display screen, to enable a user to resolve invalid configurations.

In a second aspect, the invention provides a method for coordinated, rule-based monitoring of a plurality of heterogeneous components of a data processing system. The method includes accessing one or more repositories of information (which may include configuration information, performance information, etc., for the components) and performing rule-based processing of that information on behalf of the components which provide their information to the repositories.

This enables deductions to be made about the overall system. Integrated, rule-based processing of information for a number of different components of a system can simplify the useful integration of tooling for several systems and components within an overall integrated data processing solution.

The invention preferably provides a method for checking configuration of components of a data processing system using a configuration coordinator tool which is separate from the components to be checked, which accesses information for the components and applies validity rules to check the validity of the configuration information. Encapsulating validity checking rules into a single tool, which is separate from the program or programs being checked, provides a number of advantages over the conventional approach of distributing checking code throughout the main program code. It greatly simplifies updating of the checking rules, enables cross-checking between programs, simplifies and enables automation of analysis and diagnosis of the overall system, and allows the main program code to be simplified by omission of checking code. The tool which includes validity checking rules can be located at a single point of control for the systems being managed.

In further aspects of the invention, rules are provided for correcting and setting up configurations. These may be automated to determine required configuration changes and to carry out those changes—either without reference to the user or as rules-based configuration assistance within a Wizard-writer which provides instructional help for setting or correcting configuration information.

Tools for performing the various aspects of the present invention may be implemented as computer program products, comprising machine-readable program code recorded on a machine-readable recording medium for controlling the operation of a data processing apparatus on which the program code executes.

In further aspects, the invention provides a data processing apparatus including: a plurality of data processing components, which output information to one or more repositories; a configuration control tool located at a point of control node of the data processing apparatus for accessing the information in the repositories to perform a method as described above; and a display screen for displaying the results of processing by the configuration control tool.

### BRIEF DESCRIPTION OF DRAWINGS

Preferred embodiments of the present invention will now be described in more detail, by way of example, with reference to the accompanying drawings in which:

FIG. 1 is a schematic representation of a set of components within a data processing network, including tooling at a single point of control, such as is known in the art;

FIG. 2 is a schematic representation of a set of components of a network in which a first embodiment of the present invention has been implemented;

FIG. 3 is a schematic representation of a set of components according to a second embodiment of the invention; and

FIG. 4 is a representation of a sequence of steps of a method according to the invention as implemented for a set of components according to FIG. 2 or FIG. 3.

### DETAILED DESCRIPTION OF PREFERRED EMBODIMENTS

The invention will be described in detail below using the implementation example of software-implemented tooling enabling monitoring and control of software-implemented components of a data processing system, although it will be understood by persons skilled in the art that the present invention could be implemented using any combination of software, firmware and hardware depending on the desired characteristics of the specific solution. The tooling and system components may be distributed across a plurality of different data processing systems and may pass data between them using a variety of different communication techniques and either fixed or wireless communication links. The present invention is thus not limited to any particular subset of application programs, operating systems, communication mechanisms or system hardware unless this is stated to be an essential limitation herein. It is a requirement of modern integrated data processing solutions that a variety of different systems, both hardware and software, can interoperate and the present invention is suitable for implementation within such heterogeneous environments.

Since an implementation of the invention is described below in the example context of a messaging and queuing solution including queue managers and a message broker, this infrastructure will now be described as an example environment in which the present invention can be implemented, before describing specific tooling solutions according to the preferred embodiments of the invention.

Messaging and Message Brokers

IBM Corporation's MQSeries and WebSphere MQ family of messaging products are examples of commercially available ‘middleware’ products which support interoperation between application programs running on different systems in a distributed heterogeneous environment. Message queuing and commercially available message queuing products are described in “Messaging and Queuing Using the MQI”, B. Blakeley, H. Harris & R. Lewis, McGraw-Hill, 1994, and in the following publications which are available from IBM Corporation: “An Introduction to Messaging and Queuing” (IBM Document number GC33-0805-00) and “MQSeries—Message Queue Interface Technical Reference” (IBM Document number SC33-0850-01). The network via which the computers communicate using message queuing may be the Internet, an intranet, or any computer network.

IBM's MQSeries messaging products provide transactional messaging support, synchronising messages within logical units of work in accordance with a messaging protocol which gives assured once and once-only message delivery even in the event of system or communications failures. This assured delivery is achieved by not finally deleting a message from storage on a sender system until it is confirmed as safely stored by a receiver system, and by use of sophisticated recovery facilities. Prior to commitment of transfer of the message upon confirmation of successful storage, both the deletion of the message from storage at the sender system and insertion into storage at the receiver system are kept ‘in doubt’ and can be backed out atomically in the event of a failure. This message transmission protocol and the associated transactional concepts and recovery facilities are described in international patent application WO 95/10805 and U.S. Pat. No. 5,465,328.

The message queuing inter-program communication support provided by the MQSeries products enables each application program to send messages to the input queue of any other target application program and each target application can asynchronously take these messages from its input queue for processing. This achieves delivery of messages between application programs which may be spread across a distributed heterogeneous computer network, without requiring a dedicated logical end-to-end connection between the application programs, but there can be great complexity in the map of possible interconnections between the application programs.

This complexity can be greatly simplified by including within the network architecture a communications hub to which other systems connect, instead of having direct connections between all systems. Message brokering capabilities can then be provided at the communications hub to provide intelligent message routing and integration of applications. Message brokering functions typically include the ability to route messages intelligently according to business rules and knowledge of different application programs' information requirements, using message ‘topic’ information contained in message headers, and the ability to transform message formats using knowledge of the message format requirements of target applications or systems to reconcile differences between systems and applications.

Such brokering capabilities are provided, for example, by IBM Corporation's MQSeries Integrator and WebSphere MQ Integrator products, providing intelligent routing and transformation services for messages which are exchanged between application programs using IBM's MQSeries and WebSphere MQ messaging products. Message broker capabilities can be integrated within other components of a data processing system.

A multi-broker topology may be used to distribute load across processes, machines and geographical locations. When there are a very large number of clients, it can be particularly beneficial to distribute those clients across several brokers to reduce the resource requirements of the brokers, and to reduce the impact of a particular server failing. The scalability and failure tolerance of such multi-broker solutions enable messages to be delivered with acceptable performance when there is a high message throughput or a broker fails. When clients are geographically separated, it can be beneficial to have brokers located local to groups of clients so that the links between the geographical locations are consolidated, and for well designed topic trees this can result in many messages not having to be sent to remote locations.

Message Flows

The message brokers implement a sequence of processing steps on received messages using messageflows. These are sequences of processing components corresponding to paths though a message broker's program code (visually representable as a graphical sequence of processing ‘nodes’), which start and end with input and output nodes. The input nodes are responsible for receiving messages from particular queues or reading messages from particular IP connections (or for receiving messages in any other way, for example by accessing shared memory, or by retrieving a file as input). The output nodes are responsible for sending messages to required destinations—either via queues, IP connections, or other transports. Message transfer between brokers results from a neighbour destination being specified with attributes which indicate which transport is required, which may be an IP connection, a queue being handled transactionally, a queue being handled non-transactionally or another mechanism. The message flows implement rule-based message processing and filtering, with a single message flow being made up of an input node, and output node and one or more processing nodes such as a matching node, a filter or a computation node.

Message flows are created using a visual programming technology to support broker capabilities such as publish/subscribe message delivery, message transformation, database integration, message warehousing and message routing, and which greatly ease the task of management and development of message brokering solutions. A message flow represents the sequence of operations performed by the processing logic of a message broker as a directed graph (a message flow diagram) between an input queue and a target queue. The message flow diagram consists of message processing nodes, which are representations of processing components, and message flow connectors between the nodes. Message processing nodes are predefined components, each performing a specific type of processing on an input message. The processing undertaken by these nodes may cover a range of activities, including reformatting of a message, transformation of a message (e.g. adding, deleting, or updating fields), routing of a message, archiving a message into a message warehouse, or merging of database information into the message content.

Tooling for Managing the Messaging System

It is known in the art for configuration tooling for a single data processing system to use a three layer structure:

1. The running system, including the local working system configuration;

2. A configuration server, including a central repository of configuration information; and

3. A configuration tool, which holds an in-memory copy of a subset of the configuration information to enable processing of that information.

In simpler cases, a two level system is used omitting the configuration server. Various methods are used for communication between existing tools and their configuration servers, and between the configuration server and the running system. The behaviour of the tool will depend on the level and style of configuration information caching which is used.

It is also known in the art to bring the tooling for several such systems together at a single point of control. The components running at the point of control are typically Web clients, eBaf clients, or Microsoft Management Consoles. All GUI control happens via interaction with this point of control component, although there is some variation as to how and where scripted control is applied. As much as possible, a single meta-model is used to describe all the systems—for example all may be described in the widely supported Unified Modelling Language (UML). The tool and configuration server hold a UML definition for each of the systems. The tool additionally holds details of how each system is to be presented on the screen. The information about the instances for each system are held in a suitable format for the chosen model: for example in extensible Markup Language (XML). However, such systems have very little information that relates the models and instances for the systems ‘integrated’ at the single point of control, and are therefore not able to help with inter-system designs and problems.

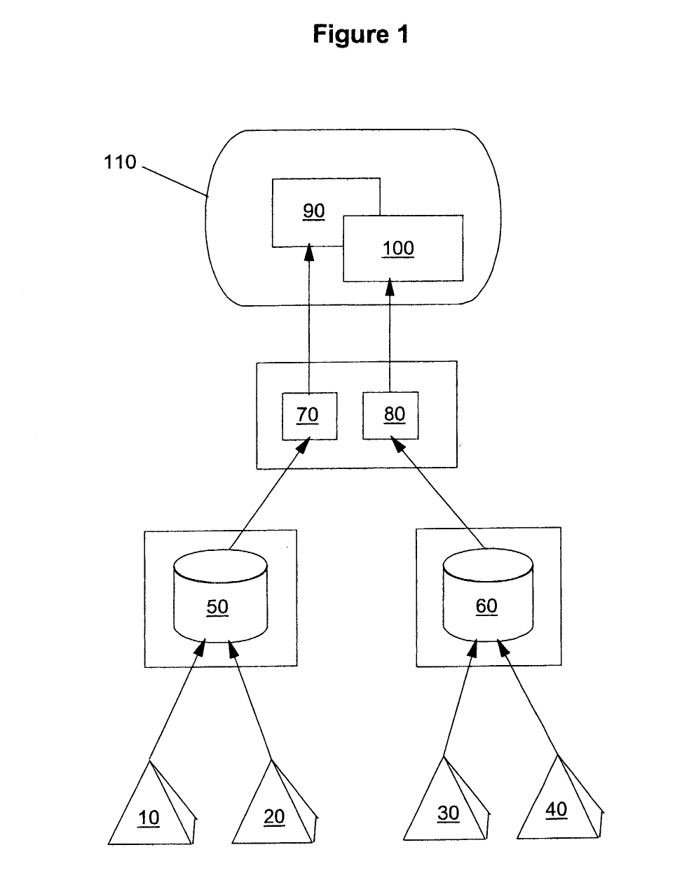

FIG. 1 is a schematic overview of an example network in which one or more control programs running at a single point of control are assisting management of a plurality of different components of a data processing system. A set of system components 10, 20, 30, 40 (which may each be, for example, computer program components of a message-oriented middleware solution) each include integral program code for outputting information such as configuration information to a repository 50, 60 of a respective configuration server. This information is output in response to a user command whenever the user wishes to check configuration settings. The information for each of components 10, 20, 30, 40 can be displayed by the control programs 70, 80 in separate windows 90, 100 of a single display console 110. Control program 70 may be, for example, the aforementioned IBM's MQSeries Explorer management console component. The consolidation of views from different control programs 70, 80 is enabled by the aforementioned Eclipse tooling.

A system according to a preferred embodiment of the present invention retains the fundamentals of this known infrastructure, and adds a rules processing capability at the point of control program. This rules capability may be implemented in Prolog, for example with the information output by the set of system components being represented as Prolog facts. Alternatively, ‘Prolog power’ Java packages could be used for easy integration with existing and proposed tools infrastructures.

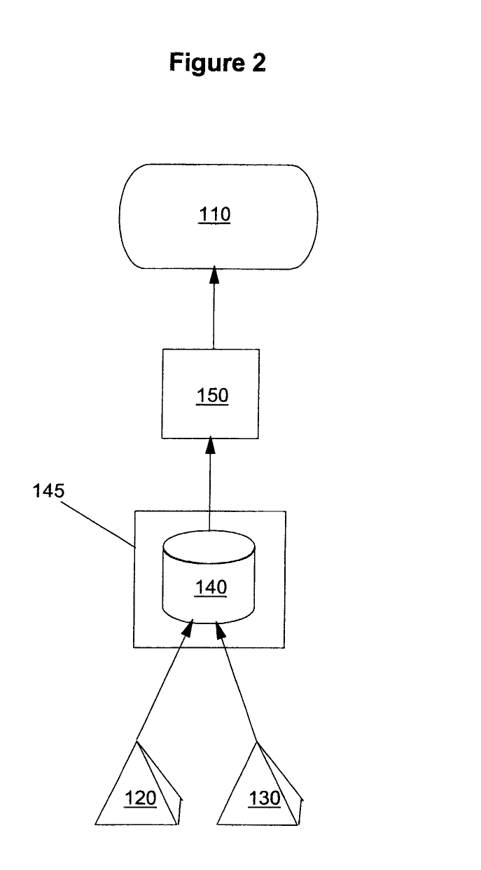

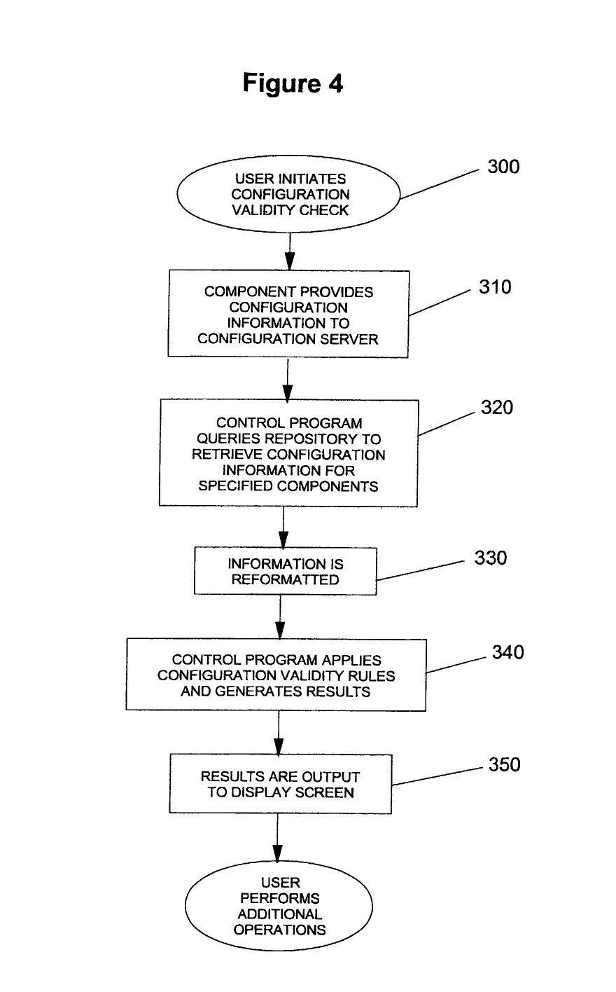

FIG. 2 shows a set of components of a network in which a first embodiment of the present invention has been implemented. The method of operation of this set of components will be described with reference to FIGS. 2 and 4. Two software components 120, 130 are outputting 310 information to a repository 140 of configuration server 145 under the control of program code integral to each of the individual components 120, 130. It should be noted that this passing of information from the monitored components can use the same mechanisms as the prior art solutions mentioned above, or alternatively may be implemented using data retrieval agents which are installed separately from the monitored components—potentially on a different system and using network communications to query the monitored components. Even if not integral to the components 120, 130, the program code for controlling outputting of information will typically have been written by a developer of the components to be monitored, since it requires knowledge of the internal characteristics of these components.

The outputting of data to the configuration server is typically triggered by a command entered 300 by a user working with a control program 150 location at a single point of control node of the network. The control program 150 then accesses 320 the information from the repository and applies 340 a set of processing rules to check the validity of the stored information and then to output 350 the results of that processing for display on a display screen. The precise mechanism for data retrieval from the repository 140 is not important—it may be in response to requests from the control program 150, and these may be triggered by user-specified queries, or the provision of data to the control program could use a ‘push’ protocol initiated from the configuration server 145 which holds the repository. However, in many cases, the data held in the repository will need to be reformatted 330 prior to rules processing by the control program 150. Although many implementations are possible, depending on the form in which the data is collected and the form required by the particular rules-based control program, a first implementation uses Perl to convert the output facts (such as the output of the IBM's MQSeries product's ‘runmqs’ command) into Prolog facts. An example, comprising an extract from the ‘dis qlocal(*) all’ subcommand of ‘runmqsc’ is as follows:

AMQ8409: Display Queue details.

| | |
|---|---|
| CLUSNL( ) | QUEUE(realfred) |
| TYPE(QLOCAL) | SCOPE(QMGR) |

After translation into Prolog facts, this becomes:
queue(“realfred”, qm(“QM_toddtp”), 2).
queueattr(queue(“realfred”, qm(“QM_toddtp”), 2), “TYPE”, “QLOCAL”)

The application of processing rules 350 include cross-checking between the information stored for each of the components 120, 130, as will be described later. The rules processing component 150 may include general purpose utility rules (perhaps defined by the infrastructure provider) in addition to component-specific rules for assessing the validity of the information output by each component. The latter set of rules will typically have been written by a developer who has detailed knowledge of the components being monitored, so that the rules can be applied by a relatively unskilled user to check the validity of settings and attributes for these components. The user either defines queries or selects from a set of predefined queries via a high level interface such as a GUI.

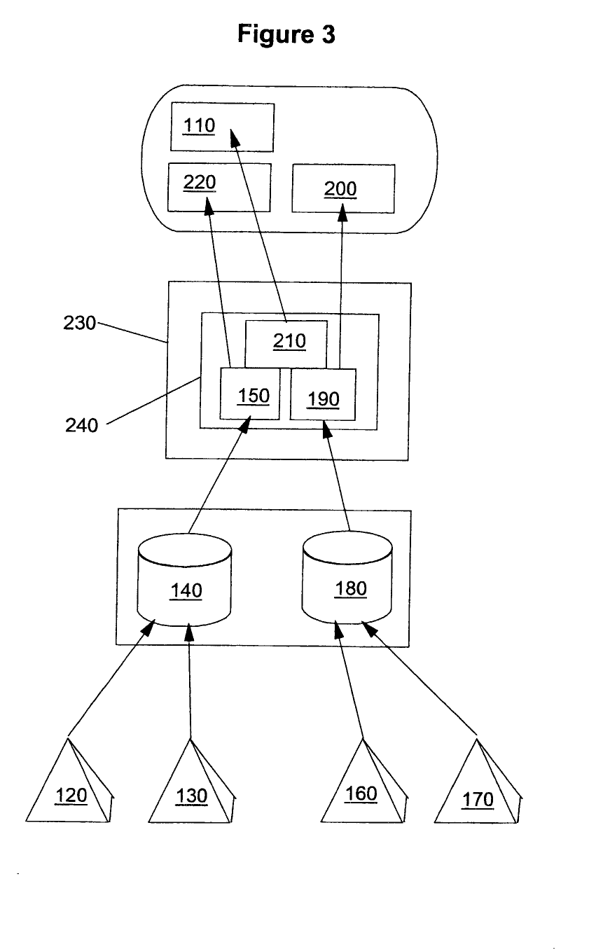

FIG. 3 shows a set of components according to a second embodiment of the invention. Similarly to FIG. 2 and consistent with FIG. 4, software components 120, 130, 160 and 170 each output information to a respective repository 140, 180, preferably under the control of code integral to those monitored components in response to a user entered command, as described above.

A control program 240 located at a single point of control system 230 includes a set of rules for checking the stored information. Unlike the example of FIG. 2, the set of rules according to this embodiment includes (in addition to general utility rules):

a first set of rules 150 which relate to the configuration settings and attributes validity of a first type of system component 120, 130—for applying to the configuration information stored for each of the components of that type, and for cross-checking between them;

a second set of rules 190 which relate to the configuration settings and attributes of a second type of system component 160, 170; and

a third set of rules 210 which are consistency checking rules for checking consistency between heterogeneous, federated components of the overall system. These rules will be described in more detail below.

This enables checks such as ensuring that a queue-manager-controlled target queue specified for use by a message broker is actually defined for the particular queue manager. Such cross-checking between heterogeneous components requires an understanding of the heterogeneous set of components, and therefore such rules are likely to have been written by a systems management expert or software developers within the vendor companies of the components to be monitored.

The reason for noting who will typically define the appropriate set of rules for each individual component, for cross checking between components of the same type, and for cross-checking between heterogeneous components is that a solution according to a preferred embodiment of the invention provides a control program comprising a set of rule-based processing modules 150, 190, 210 in which each module is structured to enable new rules to be added as required by programmers having sufficient knowledge of the components to be monitored.

In particular, the control program 240 according to preferred embodiments of the invention includes rules 210 for comparing configuration information output by a first component with configuration validity rules defined for a second component, such as where the information output by the first component include a reference to a resource of the second component to enable run-time binding and intercommunication. The rules 210 also include rules for checking that validly defined configuration settings resolve to existing and valid resources of the second component. An example is where a first computer program component of a messaging solution is configured to send messages to a specified message queue on a specified queue manager. The rules enable a check to be performed that the queue name is a valid name format and that the queue name resolves to a queue which actually exists on the specified queue manager.

In general, the consistency rules relate facts output by a first component to configuration rules defined for a second component. More particularly, where an output fact from a first component comprises a reference to a resource of a second component for enabling interoperability, the rules enable a check that the reference conforms to configuration requirements of both the first and second component and that the reference correctly resolves to an existing and valid resource.

The results of applying these sets of rules, which are output 350 from the control program in response to queries after applying rules to the input facts, can be displayed on a single display screen to identify and enable resolution of all configuration validity problems. The defined rules may include suggestions of valid facts (for example configuration settings) which the user can select to resolve the identified validity problems, and rules may be provided for automatic correction of some invalid configuration settings. Diagnostic tools can also be implemented at the point of control, or accessible from the point of control, for further problem analysis or correction.

Returning to the example of a distributed data processing system including a set of heterogeneous components of a messaging solution, the set of components making up the total solution may include, for example, one or several message queue managers for asynchronous message delivery between the input queues served by of application programs, database management programs and associated storage, database change capture components, a message broker for performing formatting and other transformations of messages, and for publish/subscribe routing, any required adapters for performing additional format conversions, system management and workflow management programs, and a number of application programs which rely on the underlying middleware to enable communication and interoperation. This infrastructure will rely on the services of the underlying operating system software on each computer in the distributed system. It is well known by persons skilled in the art that the integration and configuration of a complex set of system components is a complex and time-consuming task, and there is considerable scope for configuration errors.

The information provided to the repositories by each of these system components can be any facts about the components, and may be represented in various ways such as by Prolog facts. For example, a message queue manager may output its own unique identifier, a list of the defined queues it is responsible for, and the attributes of both the queue manager and the queues. A message broker which is configured for communication with the queue manager may include these same output facts as part of its output configuration information if the output nodes of the message broker include binding references to a queue manager's message queue.

A very simple example of an invalid configuration in this context can arise where queues can be defined for a single queue manager by alias, so that the name used by the program does not exactly match the real queue to be used. For example,

define qlocal (‘realfred’)

will define a queue called realfred, whereas

define qalias(‘fred’) targq(‘realfred’)

will define an alias queue, so that the program which writes to queue ‘fred’ will actually cause messages to be placed on queue ‘realfred’. This is fine so far, but if a real queue has not been defined then the following alias queue definition is invalid and attempts to write to queue ‘bill’ will fail:

define qalias(‘bill’) targq(‘realbill’)

The present invention will identify problems of this type—verifying that all aliases and transmission queues on a given queue manager resolve properly—to enable any configuration problems for the queue manager to be dealt with. In a Prolog implementation of the invention for use with this infrastructure, queues are identified by a queue manager name (such as qm(“QM_toddtp”) in the example below), a queue name and a queue number to differentiate between queues of the same name on other queue managers and to differentiate between multiple definitions using the same queue name on the same queue manager. An example set of Prolog facts and rules for identifying the problem is shown below in Sample 1 (% indicates a comment).

Sample 1

Facts and Rules for Message Queue Manager Local and Alias Queue Resolution

%%%%%%%%%%%%%%%%%%%%%%%%%%%%%%%%%%%%%%%%%%%%%%%%%%%
%%%%% Begin with the facts that represent the queues defined in the system.
% These will be extracted automatically from the queue manager
% The first fact states there is a queue ‘realfred’ defined on queue
% manager ‘QM_toddtp’, with a number (to ensure uniqueness) ‘2’.
% The second fact states that this is a local queue.

queue(“realfred”, qm(“QM_toddtp”), 2).
queueattr(queue(“realfred”, qm(“QM_toddtp”), 2), “TYPE”, “QLOCAL”).

% There will be many other facts to define other attributes of local
% queue realfred, queue #2
% The first fact states there is a queue ‘fred’ defined on queue manager
% ‘QM_toddtp’, with a unique number ‘3’.
% The second fact states that this is an alias queue.
% The third fact states that this ‘resolves’ to the queue ‘realfred’.

queue(“fred”, qm(“QM_toddtp”), 3).
queueattr(queue(“fred”, qm(“QM_toddtp”), 3), “TYPE”, “QALIAS”).
queueattr(queue(“fred”, qm(“QM_toddtp”), 3), “TARGQ”, “realfred”).

% There will be many other facts to define other attributes of alias queue
% fred, queue #3.
% Now define another alias queue, that will not be resolved (there is no
% real queue ‘realbill’).

queue(“bill”, qm(“QM_toddtp”), 3).
queueattr(queue(“bill”, qm(“QM_toddtp”), 3), “TYPE”, “QALIAS”).
queueattr(queue(“bill”, qm(“QM_toddtp”), 3), “TARGQ”, “realbill”).

%%%%%%%%%%%%%%%%%%%%%%%%%%%%%%%%%%%%%%%%%%%%%%%%%%%%%%%%%%%%%%%%%%%%%%
%%%%% utility rules to make the main rules easier to write
% write with carriage return

| | |
|---|---|
| writeln(X) | :- write(X), nl. |

% list all matches

| | |
|---|---|
| list(X) | :- write(“---------”), writeln(X), fail. |
| list(X) | :- X, write(“..”), writeln(X), fail. |
| list(X) | :- writeln(“--------- end of list”), nl. |

%%%%%%%%%%%%%%%%%%%%%%%%%%%%%%%%%%%%%%%%%%%%%%%%%%%%%%%%%%%%%%%%%%%%%%
%%%%% Now some Prolog rules about MQSeries queue resolution.
% First the rules about resolution of local queues (trivial) and alias
% queues.
% The first ‘parameter’ is the queue to be resolved.
% The second ‘returns’ the queue to which it resolves.
% The third gives a path that describes the resolution rules used.

resolve(Q, Q, [Q]) :- queueattr(Q, “TYPE”, “QLOCAL”).

% A local queue ‘resolves’ to itself.

| | |
|---|---|
| resolve(Q, TQ, [Q, alias, TQ]) :- | |
| queueattr(Q, “TYPE”, “QALIAS”), | % Q is an alias queue |
| queueattr(Q, “TARGQ”, TQname), | % Q has a target queue named |
| | % TQname |
| queueattr(TQ, “TYPE”, “QLOCAL”), | % TQ is a local queue |
| Q = queue(Qname, QM, Qid), | % Q is on queue manager QM (and |
| | % has name Qname and id Qid) |
| TQ = queue(TQname, QM, TQid). | % TQ is on the SAME queue |
| | % manager QM as Q. |

% Now we have a rule that looks at queues which cannot be resolved.

| | |
|---|---|
| noresolve(Q) :- | |
| queue(Qn, Qm, Qid), | % search the queues |
| Q = queue(Qn, Qm, Qid), | % match any queue with this one |
| not(resolve(Q, TQ, L)). | % and see if it resolves, let |
| | % it through if it does NOT. |

%%%%%%%%%%%%%%%%%%%%%%%%%%%%%%%%%%%%%%%%%%%%%%%%%%%%%%%%%%%%%%%%%%%%%%
%%%%% Now we can run a simple query session that will show the resolved
%%%%% and unresolved queues.

| | |
|---|---|
| ?- | list(resolve(Q, TQ, L)), |
| | list(noresolve (Q)). |

%%%%%%%%%%%%%%%%%%%%%%%%%%%%%%%%%%%%%%%%%%%%%%%%%%%%%%%%%%%%%%%%%%%%%%
% ======= Result: here is output from a run, using %> to show output lines
%> ---------resolve(_0, _1, _2)
%> . .resolve(queue(“realfred”, qm(“QM_toddtp”), 2),

| | |
|---|---|
| %> | queue(“realfred”, qm(“QM_toddtp”), 2), |
| %> | [queue(“realfred”, qm(“QM_toddtp”), 2)]) |

%> . .resolve(queue(“fred”, qm(“QM_toddtp”), 3),

| | |
|---|---|
| %> | queue(“realfred”, qm(“QM_toddtp”), 2), |

%> [queue(“fred”, qm(“QM_toddtp”), 3), alias, queue(“realfred”, qm(“QM_toddtp”), 2)
%>])
%> --------- end of list
%>
%> ---------noresolve(_0)
%> . .noresolve(queue(“bill”, qm(“QM_toddtp”), 3))
%> --------- end of list
%%%%%%%%%%%%%%%% END OF PROLOG SAMPLE %%%%%%%%%%%%%%%%%%%%%

More complicated rules are also required for many systems, for example to track messages defined using local definitions of remote queues. These rules can include application of an understanding of transmission queues, channels, listeners, tcp addresses, etc. (which are described in the above mentioned IBM MQSeries product documentation). Additionally, rules which identify a negative result (such as the ‘noresolve’ in the above example) can be associated with code providing an explanation of the problem rather than just a non-specific invalidity statement.

A further system component, such as a message broker, will have other internal rules in a similar style, for example checking that message flows were not defined using references to subflows that did not exist. On top of this, cross-system checking rules can be added. For example, there may be message broker facts that state the existence of an MQOutput node (“mqouta”) in message broker (“mybroker”) that references a particular queue manager (“QM_toddtp”) and queue (“fred”), and correct resolution of the message broker nodes in terms of message queue manager queues can be checked as shown in Sample 2 below.

Sample 2

Facts Defining Broker Nodes, and a Cross System Rule That Verifies Correct Resolution of These Nodes in Terms of a Queue Manager's Queues

%%%%%%%%%%%%%%%%%%%%%%%%%%%%%%%%%%%%%%%%%%%%%%%%%%%%%%%%%%%%%%%%%%
%%%%%% now some facts about a second component - a message broker
% define three broker mqoutput nodes, firstly using ‘good’ queue fred:

node(“mqouta”, “mybroker”, mqoutput(“QM_toddtp”, “fred”)).

% secondly using ‘unresolved’ queue bill:

node(“mqoutb”, “mybroker”, mqoutput(“QM_toddtp”, “bill”)).

% thirdly using undefined queue bert:

node(“mqoutc”, “mybroker”, mqoutput(“QM_toddtp”, “bert”)).

%%%%%%%%%%%%%%%%%%%%%%%%%%%%%%%%%%%%%%%%%%%%%%%%%%
%%%%%% and some cross system rules, relating broker facts and rules (the
%%%%%% broker is referenced in this code as mqsi) to queue manager facts
%%%%%% and rules (the queue manager is referenced as QM)
% A rule will find that a node resolves correctly into queue manager, and
% what the queue manager resolution is.

| bind(node(Nodename, Broker, mqoutput(QM, Qname)), TQ) :- | |
|---|---|
| node(Nodename, Broker, mqoutput(QM, Qname)), | % find/test mqsi node |
| Q = queue(Qname, qm(QM), Qid), | % make a queue |
| | % definition |
| Q, | % test queue exists |
| resolve(Q, TQ, L). | % and that it |
| | % correctly resolves |

% A not rule will find the errors.

```
nobind(node(Nodename, Broker, mqoutput(QM, Qname))) :-
  node (Nodename, Broker, mqoutput (QM, Qname)),
  not (mqsibind (node (Nodename, Broker, mqoutput (QM, Qname)), TQ)).
```

%%%%%%%%%%%%%%%%%%%%%%%%%%%%%%%%%%%%%%%%%%%%%%%%%%
%%%%%% and a cross system query:

| | |
|---|---|
| ?- | list(mqsibind(Node, TQ)), |
| | list(nomqsibind(Node)). |

%%%%%%%%%%%%%%%%%%%%%%%%%%%%%%%%%%%%%%%%%%%%%%%%%%
% ======= Results: here is output from a run, %> showing output lines
%> ---------mqsibind(_0, _1)
%> . .mqsibind(node(“mqoutb”, “mybroker”, mqoutput (“QM_toddtp”, “fred”)),

| | |
|---|---|
| %> | queue(“realfred”, qm(“QM_toddtp”), 2)) |

%> --------- end of list
%>
%> ---------nomqsibind(_0)
%> . .nomqsibind(node(“mqouta”, “mybroker”, mqoutput(“QM_toddtp”, “bill”)))
%> . .nomqsibind(node(“mqouta”, “mybroker”, mqoutput(“QM_toddtp”, “bert”)))
%> --------- end of list

Sample 3 shows an example of rules written in Prolog that explain the reason for failures, rather than just that the failure has happened. (Some other rule-based systems have built-in explanation capabilities and could be used as an alternative to Prolog.)

Sample 3

A Variant of Sample 2 That Gives Reasons for Failures of Broker Bindings to Queue Manager

%%%%%%%%%%%%%%%%%%%%%%%%%%%%%%%%%%%%%%%%%%%%%%%%%%
%%%%%% first some utility rules
% try is a general purpose rule that simplifies writing rules with
% explanations. try takes

| | |
|---|---|
| % | (1) a list of goals and intents, |

| | |
|---|---|
| % | [goal1, intent1, goal2, intent2, . . .] |

| | |
|---|---|
| % | (2) a (returned) Reason. |

% try executes the goals in turn.
% If all the goals succeed, Reason remains unbound.
% If a goal fails, the goal and its intent are returned in Reason.
% In either case, try succeeds.

| | |
|---|---|
| try([_], ). | % all the goals have succeeded |
| try([Rule , Reason \| Rest], Result) :- | % rule for successful goal |
| Rule, | % attempt the first goal |
| try(Rest, Result). | % and if ok, try the remaining |
| | % goals |
| try([Rule , Reason \| Rest], Result) :- | % rule for failing goal |
| not(Rule), | % first goal fails |
| Result = failed(Reason, Rule). | % so give the reason for failure |

%%%%%%%%%%%%%%%%%%%%%%%%%%%%%%%%%%%%%%%%%%%%%%%%%%
%%%% now a cross system rule that gives reasons
% mqsibindR is a rule that uses try to check MQ binding of broker mqoutput
% nodes. mqsibindR will process all broker mqoutput nodes matching its first
% parameter. For each node, it will either
% (1) return the resolved MQSeries queue in the second parameter (TQ), or
% (2) return the reason for failure in the third parameter (Result).
mqsibindR(node(Nodename, Broker, mqoutput(QM, Qname)), TQ, Result) :-

| | |
|---|---|
| node(Nodename, Broker, mqoutput(QM, Qname)), | % find broker mqoutput |
| | % node |
| try([ | |

| | |
|---|---|
| Q = queue(Qname, qm(QM), Qid), | “make MQ format queue”, |
| Q, | “check MQ queue exists”, |
| resolve(Q, TQ, L), | “resolve MQ queue”], |
| Result). | |

```
% nomqsibindR picks up just the cases where mqsibindR returned some
% failure reason.
nomqsibindR(Node, Result) :-
  mqsibindR(Node, TQ, Result),
  not(var(Result)).
%%%%%%%%%%%%%%%%%%%%%%%%%%%%%%%%%%%%%%%%%%%%%%%%%%
%%%%%%%%%% a query using these rules:
```

| | |
|---|---|
| ?- | list(mqsibindR(Node, TQ, Result)), |
| | list(nomqsibindR(Node, Result)), |
| | fail. |

%%%%%%%%%%%%%%%%%%%%%%%%%%%%%%%%%%%%%%%%%%%%%%%%%%
%% ========================================
%% Results: annotated output of run, in which %> indicates a real output
%% line, and %% an annotation line
%> ---------mqsibindR(_0, _1, _2)
%%%%% list out all the results, whether ok or not
%% first one ok, resolves fred to realfred
%> . .mqsibindR(node(“mqouta”, “mybroker”, mqoutput(“QM_toddtp”, “fred”)),

| | |
|---|---|
| %> | queue(“realfred”, qm(“QM_toddtp”), 2), _2) |

%% second fails, can't resolve queue bill
%% (In a more complete system where the MQ rules also gave failure reasons,
%% the MQ failure reason would also be indicated here.)
%> . .mqsibindR(node(“mqoutb”, “mybroker”, mqoutput(“QM_toddtp”, “bill”)), _1,

| | |
|---|---|
| %> | failed(“resolve MQ |
| %> | queue”, resolve(queue(“bill”, qm(“QM_toddtp”), 3), _1, _26))) |

%% third fails, can't even find queue bert
%> . .mqsibindR(node(“mqoutc”, “mybroker”, mqoutput (“QM_toddtp”, “bert”)), _1,

| | |
|---|---|
| %> | failed(“check MQ queue |
| %> | exists”, queue(“bert”, qm(“QM_toddtp”), _22))) |

%> --------- end of list
%%%% second listing just showing the failing nodes (with reasons)
%>
%>--------nomqsibindR(_0, _2)
%> . .nomqsibindR(node(“mqoutb”, “mybroker”, mqoutput(“QM_toddtp”, “bill”)),

| | |
|---|---|
| %> | failed(“resolve MQ |
| %> | queue”, resolve(queue(“bill”, qm(“QM_toddtp”), 3), _17, _40))) |

%> . .nomqsibindR(node(“mqoutc”, “mybroker”, mqoutput(“QM_toddtp”, “bert”)),

| | |
|---|---|
| %> | failed(“check MQ queue |
| %> | exists”, queue(“bert”, qm(“QM_toddtp”), _36))) |

%> --------- end of list

As can be seen from the above examples, the rules defined include the following types:

1) Rules that manipulate the instance information to produce tailored presentation views.

For example:

(1a) In a messaging and queuing solution (such as using IBM Corporation's WebSphere MQ messaging middleware products—referred to herein as MQ for simplicity), for a given queue manager show all ‘final’ target queue managers and queues for defined local definitions of remote queues, allowing for the MQ alias, channel, etc. rules.

(1b) In a message broker including publish/subscribe capability with security controls (such as using IBM Corporation's WebSphere MQ Integrator products—referred to hereafter as MQ Integrator for simplicity), present the rules that will be used.

(1c) In a solution using IBM Corporation's DB2 database software and the Data Propagator component, show the relationship between ‘source’ tables being monitored for change, and ‘target’ tables being updated; indicating the processes that must be running to ensure correct replication.

2) Rules that manipulate the instance information to verify or enforce ‘consistency’ within a single monitored component of the overall system.

For example:

(2a1) MQ: as in (1a), but highlight local definitions if no sensible target queue will be reached. Alternatively, list all such ‘bad’ definitions over the known MQ network, and explain reason for identified bad definitions.

(2a2) For a given queue, show all possible destinations for message put on that queue (assuming no configuration change), and reason for ‘error’ destinations which would result in a static lost message.

(2b) MQ Integrator: As in (1b), highlight cases where ‘unexpected’ results might be obtained, for example where a user is in two groups, and one group is ‘allowed’ subscription for a given topic and the other is ‘denied’.

(2c) Data Propagator: Highlight replications that will fail because of inconsistent set-up.

3) Rules that permit cross-component presentation views.

For example:

(3a) A set of rules that ‘expand’ all the MQ Integrator macros etc. and find the resources (database tables, queue managers and queues) uses by various flows and execution groups. They then display these as a map that just shows (a) machines, (b) MQ Integrator brokers, (c) resources.

4) Rules that manipulate the instance information to verify or enforce ‘consistency’ across federated systems.

For example:

(4a) Ensure that deployment of the current MQ Integrator configuration does not involve undefined or badly defined MQ queue manager queues.

(4b) As in (3a and 4a), showing all resources that are required but not available,

(4b) see customer scenario below.

Some rules will be defined by system providers, others by system integrators, and some by customers faced with particular configuration issues. These rules can be written so as to naturally integrate and interact with one another and can be added to the respective module of the control program.

It is possible to implement all these examples using ‘standard’ scripting (as long as the tools are not so inward looking as to prevent scripting access to their instance data). A rules based approach makes such coding much simpler.

Customer Scenario

Let us assume that a customer is using an integrated data processing solution including database components, message queue manager components and message broker components:

1) Database changes are being captured by a data propagator component using message queue manager communications services.

2) They are being sent by the queue manager to a message broker.

3) They are routed through a message flow to a publish/subscribe node at the broker.

4) A subscriber has made an appropriate subscription.

5) The change message is routed to the subscriber over the message queue manager's communication mechanism.

A change is made to the database, and the expected change message does not arrive at the subscriber. The customer needs to understand why not.

The answer to this question may lie in bad configuration within a single component: for example, within the data propagator component (if there is a wrongly configured capture component), within the queue manager (if there is a wrongly configured channel, or a wrongly specified port on the listener) or within the message broker (if there is a bad message flow, or if access has been denied by publish/subscribe security controls). Alternatively, the answer may lie in the glue between systems (if the data propagator component is writing to the wrong queue for example). It is clear that in many real systems, the scope for potential configuration problems is very great and there can be considerable difficulties in understanding and correcting such problems.

To solve this problem with conventional ‘single point of control’ tooling involves a huge amount of effort on the part of the administrator, with many interactions with each of the system components involved. In addition, it involves very detailed knowledge on the administrator's part of the detailed rules of all the system components involved.

The proposed federated rule system according to the present invention can identify the answer to such problems much more easily than known solutions. This has great benefits to the customers who rely on integrated data processing solutions to manage their business' critical data. Customers will be able to put together and configure complex solutions involving many parts far more easily, and with less skill. The main benefits will be while setting up such a system (the gap between traditional application development and systems management), but there will be further benefits of improved diagnostics during the deployment and operation life cycle.

Preferred implementations of the invention include rules for correcting and setting up configurations. These may work from identified problematic configuration information to determine what changes are required to make the problematic configuration information conform to configuration requirements of the set of components, and may then apply those changes without requiring any user input. In other cases, rules will be used to provide user assistance when setting up configurations, such as within a Wizard writer. In this case, the rules will be invoked only when the Wizard is run and will typically require a positive action from the user (at least user selection) before any configuration information is set or changed.

What is claimed is:

1. A method for checking configuration validity for a plurality of components of a data processing system, comprising the steps, subsequent to the components outputting configuration information, of:
applying configuration consistency rules to check for consistency between the output configuration information for the plurality of components; and
outputting the results of the consistency check.

2. A method according to claim 1, wherein said plurality of components include components which are configured for interoperation by including, within a first component's configuration settings, references to resources of a second component, and wherein the configuration consistency rules include rules for checking whether the first component's configuration settings correspond to valid references to resources of the second component.

3. A method according to claim 2, wherein the configuration consistency rules include rules for checking whether said references resolve to existing valid resources of the second component.

4. A method according to claim 1, wherein the plurality of components include a plurality of heterogeneous components which are configured for interoperation, and wherein the configuration consistency rules include rules for checking for consistency between the configuration information for said heterogeneous components.

5. A method according to claim 4, including the steps of:
applying a first set of configuration validity rules to a first set of information output by data processing system components of a first type, wherein the first set of configuration rules are adapted to determine whether the first set of information corresponds to configuration requirements of components of the first type;
applying a second set of configuration validity rules to a second set of information output by data processing system components of a second type, wherein the second set of configuration rules are adapted to determine whether the second set of information corresponds to configuration requirements of components of the second type; and
applying said configuration consistency rules to check for consistency between items of a third set of information output by data processing system components of the first and second types, wherein the consistency rules are adapted for determining whether information output by components of the first type corresponds to configuration requirements of components of the second type.

6. A method according to claim 5, wherein the information output by components of the first type includes references to resources of components of the second type, and wherein said consistency rules are adapted for determining whether said references comprise valid references.

7. A method according to claim 1, for checking configuration validity for a plurality of components which output configuration information to one or more information repositories, including the step of retrieving the output configuration information from the one or more repositories.

8. A method according to claim 7, wherein the step of retrieving the output configuration information comprises a control program sending queries to said one or more repositories in response to user initiation of a query.

9. A method according to claim 1, including displaying to a user a notification of the identification of invalid configuration information.

10. A method according to claim 9, including displaying to a user information identifying the invalid configuration information.

11. A method according to claim 10, including displaying to a user a recommendation for replacing the invalid configuration information.

12. A method according to claim 1, including invoking a diagnostic tool in response to identification of invalid configuration information.

13. A method according to claim 1, including performing an automated determination of required changes to configuration information to conform to configuration validity rules and automated performance of said changes.

14. A method according to claim 1, wherein the plurality of components include a set of heterogeneous components of a messaging and queuing system including a message queue manager, and wherein the output configuration information includes an identification of one or more message queues managed by the message queue manager.

15. A method according to claim 14, wherein the plurality of components includes a first component configured to output messages to a message queue managed by the message queue manager, and wherein said rules include a rule for determining whether the configuration information of the first component includes a valid identification of a message queue.

16. A method according to claim 15, wherein said rules include a rule for determining whether said valid identification is resolvable to an existing valid message queue.

17. A method according to claim 1, for checking configuration validity for a plurality of components which output configuration information as a set of Prolog facts, wherein the configuration consistency rules include Prolog-based rules for processing said Prolog facts.

18. A data processing apparatus including:
a plurality of data processing components, adapted to output configuration information for access by a configuration control tool; and
a configuration control tool for applying configuration consistency rules to said output information to check for consistency between the output information for the plurality of components, and for outputting the results of the consistency check.

19. A data processing apparatus according to claim 18, wherein said plurality of components include components which are configured for interoperation by including, within a first component's configuration settings, references to resources of a second component, and wherein the configuration consistency rules include rules for checking whether the first component's configuration settings correspond to valid references to resources of the second component.

20. A data processing apparatus according to claim 19, wherein the configuration consistency rules include rules for checking whether said valid references resolve to existing valid resources of the second component.

21. A data processing apparatus according to claim 18, wherein the plurality of components include a plurality of heterogeneous components which are configured for interoperation, and wherein the configuration consistency rules include rules for checking for consistency between the configuration information for said heterogeneous components.

22. A data processing apparatus according to claim 18, wherein the configuration control tool includes:
means for applying a first set of configuration validity rules to information output by data processing system components of a first type;
means for applying a second set of configuration validity rules to information output by data processing system components of a second type; and
means for applying said configuration consistency rules to check for consistency between the information output by data processing system components of the first and second types, said consistency rules relating configuration information output by components of the first type to configuration validity requirements of components of the second type.

23. A data processing apparatus according to claim 18, including one or more information repositories, wherein the plurality of data processing components are adapted to provide the output configuration information to the one or more repositories and wherein the configuration control tool is adapted to retrieve the output configuration information from the one or more repositories.

24. A data processing apparatus according to claim 23 wherein the configuration control tool is adapted to retrieve the output configuration information from the one or more repositories in response to a user-initiated query.

25. A data processing apparatus according to claim 18, including a display screen connected to the configuration control tool for displaying the results of processing by the configuration control tool.

26. A data processing apparatus according to claim 25, including means for displaying on the display screen a notification of the identification of invalid configuration information.

27. A data processing apparatus according to claim 26, including means for displaying on the display screen information identifying the invalid configuration information.

28. A data processing apparatus according to claim 27, including means for displaying on the display screen a recommendation for replacing the invalid configuration information.

29. A data processing apparatus according to claim 18, including a diagnostic tool and means for invoking said diagnostic tool in response to identification of invalid configuration information.

30. A data processing apparatus according to claim 18, wherein the configuration control tool includes means for performing an automated determination of required changes to configuration information to conform to configuration validity rules, and means for automated performance of said changes.

31. A data processing system according to claim 26, wherein the configuration control tool includes a Wizard tool for guiding the user through a series of operations to replace invalid configuration information with valid information.

32. A data processing apparatus according to claim 18, wherein the plurality of components include a set of heterogeneous components of a messaging and queuing system including a message queue manager, and wherein the output configuration information includes an identification of one or more message queues managed by the message queue manager.

33. A data processing apparatus according to claim 18, wherein the plurality of components are adapted to output configuration information as a set of Prolog facts, and wherein the configuration consistency rules include Prolog-based rules for processing said Prolog facts.

34. A computer program product, comprising program code for controlling the operation of a data processing apparatus on which the program executes, the program code including means for performing a method according to claim 1.

35. A configuration control tool including means for performing a method according to claim 1.
